(19) United States
(12) Patent Application Publication
(10) Pub. No.: US 2012/0309971 A1
(43) Pub. Date: Dec. 6, 2012

(54) Synthetic method of organometallic iridium compound

(76) Inventors: Lifei Cai, Beijing (CN); Hongyu Zhao, Beijing (CN); Changquan Cai, Beijing (CN)

(21) Appl. No.: 13/577,768

(22) PCT Filed: Feb. 9, 2011
(86) PCT No.: PCT/CN11/70888

§ 371 Date: Aug. 8, 2012

(30) Foreign Application Priority Data
Feb. 9, 2010 (CN) 201010110482.8

(51) Int. Cl. C07F 15/00

(52) U.S. Cl. 546/5; 546/2

(57) ABSTRACT

A synthetic method for preparing organometallic iridium compounds is provided and includes the two steps of (1) synthesizing a di-iridium compound with a halogenated bridge: L₂Ir(μ−X)₂IrL₂, L; and (2) reacting L₂Ir(μ−X)₂IrL₂ with a ligand to give the product [Ĉ]N]₂Ir (LX). The invention is an improvement over the traditional method for preparing such compounds and has the advantages of shortened reaction time, increased yield, and products of over 99% purity obtained without chromatography.

### THE TECHNICAL FIELD BELONGS

The invention belongs to the chemical synthesis areas, especially which involving the highly efficient synthesis methods for organometallic Iridium compounds.

### TECHNICAL BACKGROUND

Recent years, one reason that OLED science and technology field made a breakthrough is because of the discovery of electro-phosphorescence. With the use of it, commonly used device can level up the internal quantum efficiency of its fluorescent dopant from 25% up to 100%.

Organic Light Emitting Diode luminesces when electron-hole pair held together then produced the exciton which dispersed to emitting layer. On the basis of theoretical speculation, the ratio of single excited state to treble excited state, both of which produced from electron-hole pair held together, is 1:3. And base on this, the energy can be used for luminescence is no more than 25%, the remaining 75% of energy lost due to the treble excited state but by non-luminescence Mechanism. So that, for the flourescent material, the internal quantum efficiency ratio of which is no more than 25%. The research on how in the form of light to release the energy of treble excited state, which means the improvement of device quantum efficiency, has played an important role in R&D of Organic Light Emitting Diode. In 1998, professor Baldo and Forrest, et al. at the University of Princeton discovered that triplet phosphorescence can be in use at room temperature (Baldo, M. A., et al., Nature, 1998, 395, 151.), and the internal quantum efficiency ratio, no more than 25%, then was leveled up even close to 100%. Phosphorescence gives a performance of efficient light-emitting property, which gave researchers an impetus for further developing the high-performance phosphorescent materials. Here Iridium material is a kind of widely used phosphorescent material. In terms of the molecular structure, Iridium materials can be classified into two groups: uniligand and different ligands. By differing ligand, a variety of colors can be produced. (Kwong R., et al, US20080261076; Lamansky S., et al., Inorg. Chem. 2001, 40, 1704-1711).

All the Iridium compounds can be synthetized using iridous chloride hydrates and the corresponding ligands. The reactions produced double Chloride bridges with [ĈN]₂Ir(μ−Cl)₂[ĈN]₂, then took another one step reaction, the target Iridium compounds [C]̂]N]₂IR(LX)can be produced, and the third ligands LX of which can be same or not. In recent years, Du Pont's research team developed a new method by which the synthesis of organometallic Iridium compounds needed only one step reaction. The method is that under the catalysis of by a small amount of Silver tri-Fluoromethanesulfonate had the Iridous chloride reacted with an excess of ligands, single-ligand Iridium compounds were produced. (Grushin V. V., et al., Chem. Commun., 2001, 1494-1495). At the same time, using this method would bring some problems which are as follows: ligands were as reactants and solvent which means cost increase, meanwhile the method can be used only for Iridium compounds with the same ligands, not those with two kinds of ligands. University of Southern California provided a method on the synthesis of Iridium compounds, which can be used for those with different ligands. (Lamansky S., et al., Inorg. Chem. 2001, 40, 1704-1711). However, using this method, synthesis time reached 24 hours, and purity is no high which means to achieve OLED device request the column chromatography, etc. as well as much manpower would be followed. Becker, H. et al. reported that by using Iridium (III) 2,4-pentanedionate as starting material (US20040077862), synthesis of Iridium compounds can be achieved in one step reaction. However, synthesis of the Iridium (III) 2,4-pentanedionate is not easy. And the method may be only suitable for laboratory studies. Although a huge number of reports about Iridium compounds, the column chromatography always needed with the disadvantage which means longer reaction time. A method which can improve both productivity and purity is needed.

### THE CONTENTS OF THIS INVENTION

On the basis of a great amount predecessors' work as well as the research on the advantages and disadvantages of various methods, the invent presents an efficient method of synthesis of Iridium compounds. Improved based on the current method, the new method is with advantage of high yield, high purity of the product, shorter reaction time, no need of complicated operation, and lower cost.

Two step sole reactions are needed for the synthesis of organometallic Iridium compounds are as follows: (1) Iridium tri-Halides hydrates reacted with neutral ligands, the reaction gave the di-Iridium compounds branched with halogenated bridge: L₂Ir(μ−X)₂IrL₂, L: Bi-coordinated circular metal ligand formed from Neutral ligands, (μ−X): Halogenated bridge. (2) Di-Iridium compounds branched with halogenated bridge react with a slightly excessive dose of ligand B, then the reaction gives[Ĉ]N]₂IR(LX)LX: Ligand III formed from ligand B. The distinguishing features of the method are as described below. Proceed of the first as follows: Iridium tri-halides hydrates are dissolved in water, and then dropped in the reflux of Neutral ligands and soluble organic solvent A. After 2-6 hours refluxed, the output would be filtered and then recrystallized, finally gives the di-Iridium compounds branched with halogenated bridge: L₂Ir(μ−X)₂IrL₂, L.

The soluble organic solvent A mentioned above is as follows: 2-Ethoxyethanol, 2-Methoxyethanol, 1,3-Propandiol, 1,2-Propanediol, Glycol, or Glycerol, and 3:1-0:1 volume ratio between the above-mentioned soluble organic solvents and water is recommended.

And the minimum volume of either the above-mentioned soluble organic solvent A or the water must be enough dissolving step.

The above-mentioned Iridium tri-Halides hydrates are Iridium tri-Chloride hydrates.

The second step reaction mentioned above proceeded as follows:

Dissolved ligand B in solvent B, then dropped in the reflux of which dissolving di-Iridium compounds branched with halogenated bridge, solvent B and carbonate solution. Then after 1-6 hours refluxed, separation, gives the end products by final recrystallized step.

And the above-mentioned solvent B: 2-Ethoxyethanol, 2-Methoxyethanol, 1,3-Propandiol, 1,2-Propanediol, Glycol, Glycerol, 1,2-dichloroethane, Acetonitrile, 1,2-diethoxyethanol, or 1,2-dimethoxyethanol.

The preparation of above mentioned mixed solution: Dissolved di-Iridium compounds branched with halogenated bridge in solvent B, refluxed and then added in with carbonate solution.

The minimum volume of solvent B above mentioned must be enough dissolving step.

And the reflux step last 2-4 hours.

The above-mentioned ligand B means Neutral ligand.

The processes the invention provided are as follows: Iridium tri-halides hydrates react with neutral ligands, where the neutral ligands are uncharged, acidic or Alkaline groups, and the reaction gives the di-Iridium compounds branched with halogenated bridge: L₂Ir(μ−X)₂IrL₂, L: Bi-coordinated circular metal ligand formed from Neutral ligands, (μ−X): Halogenated bridge. The existed methods where the halogenated Iridium, the neutral ligand, solvent A commonly were refluxed for 24 hours in the flask, then the reaction can give 10% of the Iridium compounds of three different ligand, and the purification steps followed. These methods take longer time, and always introduce 10% of impurities. So these methods are not proper for the synthesis of the different iridium compounds of ligand III. We have studied the properties of all the raw materials. We dissolved halogenated Iridium with solvent A. Then after 2-6 hours refluxed in the flask, halogen bridge compounds can be produced. Finally a recrystallized step followed. The differences between the improved method and predecessors' work are as follows: We changed the additive sequence and the mode of adding material, by which the rate of reaction increased and time was saved. Meanwhile the purification processes are also greatly simplified. The solvent used in step one is the mixed solution of either organic solvent 2-Ethoxyethanol or 2-Methoxy ethanol and water with 3:1-1:1 volume ratio. The minimum volume of the solvent here must be enough dissolving step.

In the second step reaction, halogen bridge compounds we have produced reacted with a slightly excessive dose of ligand B, and here the ligands can be the same or not the same with which used in the first step reaction. The solvents we used are organic solvents including monobasic alcohol, polybasic alcohol, and polyhalohydrocarbon, etc. And we used carbonate as catalyst. Dripping reaction solution to the flask where di-Iridium compounds branched with halogenated bridge, carbonate, and solvent with ligands had been added. After refluxed 1-6 hours, the production was purified to 95% without impurity but excessive ligands, and can directly go to recrystallized and purifying step. In other patents or references, the second step reaction commonly lasts 24 hours, which easily produces impurities of as the same polar as the target production. And then many times of the column chromatography separations must be followed, and each time the production by separation and purification process can only reach to 1-2 g. The heavy losses of the productions get in the way of the use of these methods. But the invent improved the operating processes in the first step, then after recrystallized and purifying step the production with high purity can be reached. Meanwhile some hard removed impurities in the second step and some tend to react in the second step had been removed. And the improvement of the operating processes in the second step, where the additive sequence was changed, made the second step reaction easily give the production which easily to be purified. In this way, after simplified recrystallized process, the purity of the target production can reach over 99%, see FIG. 2.

The boiling point of the solvent used in synthesis of Iridium compounds is usually high. And for the uniligand, the boiling point of the solvent can reach to over 180° C.

Trace oxygen can easily damage the intermediate, therefore during the reaction the inert gases must be around. We replaced air with inert gases to keep the inert gases condition. There are fac and mer the two forms for the three identical ligand. During synthesis processes the boiling point should be considered first. High boiling point solvents promote producing fac. And the synthesis processes should be away from sunlight. The technical personnel in this field can according to routine knowledge select the solvent used in synthesis processes. In the invent, we used Iridium compounds of FirPic, Ir(ppy)₃, Ir(ppy)₂(acac), and FIr₆ to verify our thoughts. The method can also be used in the synthesis processes of other kinds of Iridium compounds. Even some change-made processes are also within the extent of the patent protection.

The synthetic method for organometallic Iridium compounds in the invent provides several advantages such as shorter reaction time, simplified separation and purification processes, greatly improved production efficiency, yield high, over 99% of the purity, and greatly reduced the cost of the reaction. The processes provided by the patent are relatively easy to remove impurities and improve yields, which adapt not only laboratory but also industrial production.

### DESCRIPTION OF FIGURES

FIG. 1: Di-(4,6-difluorophenyl Pyridine-N, C2) Pyridine Formyl Iridium/NMR spectra for FIrPic.

FIG. 2: Di-(4,6-difluorophenyl Pyridine-N, C2) Pyridine Formyl Iridium/Liquid chromatogram for FIrPic.

FIG. 3: DSC test map for FIrPic.

### THE DETAILED METHOD AND BASIC PROCESSES

Some details will have to be further elaborated as we go along with patent embodiments.

### Embodiment 1: the Synthesis of Di-(4,6-Difluorophenyl Pyridine-N, C2) Pyridine Formyl Iridium/FIrPic.

### Step One:

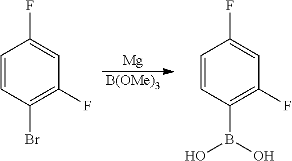

After the reaction triggered by 11 g of magnesium powder, iodine, and a small amount of 2,4-Difluoro Bromobenzene, dripped in a solution of 77.2 g of 2,4-Difluoro Bromobenzene and 400 ml of THF. The temperature was kept between 28° C. and 35° C. and maintained for the whole reaction. And the solution appeared gray.

Then after 5 hours of reaction at room temperature, then stop if no raw material was detected by pointing board. Added 54 g of Trimethoxy-boron and 400 ml of THF in the reaction bulb, then introduced in the nitrogen gas. When the temperature reached −60° C., dripped in the Grignard reagent. In less than a minute, green light appeared in the solution. With the Grignard reagent dripped in, the solution turned murky gray. When the dripping ended, the solution turned gray. With gradually lowered to room temperature, more solid substances can be seen. Overnight after, the solid substances disappeared, and the solution turned yellow turbidity.

When cooled to 0° C. and dripped in 2M of hydrochloric acid, the solution appeared white turbidity which disappeared soon, and then turned transparent yellow green, and pH value is 1. After stirred for 2 hours, the solution was separated. By using 1 L of acetic ester as solvent, and after rinsed by water for twice, 24.76G of white solid substances were obtained by followed extracting and column chromatography processes, and the yield rate was up by 40%.

¹HMNR (CDCl₃, 400Hz): 7.83 (1H, m), 6.94 (1H, m), 6.8 (1H, m).

### Step Two:

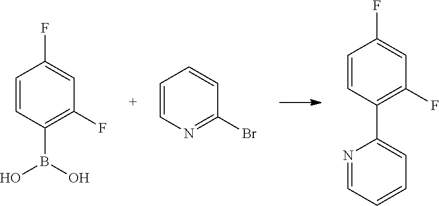

Added 200 ml of THF, 24.76 g of 2,4-Difluoro Boric acid and 22 g of 2-Bromopyridine to 1 L of four-neck flask, the solution appeared light tawny. Then added 52 g of Potassium carbonate in the solution, and yellow turbidity appeared. Then the Nitrogen gas was introduced in for 15 minutes. Added 1 g of Tetraphenyl-Phosphine-Palladium to the solution and heated, then refluxed when warmed to 61° C. As heated for 4 hours, the solution turned brown. Then the cooling and separating process, water layer was extracted with 300 ML of Ethyl Acetate, and then followed with merging and distillation steps. Finally, 25 g of white solid products can be reached by column chromatography with petroleum ether as solvent. The yield rate reached 83.5%.

¹HNMR (CDCl₃, 400Hz): 6.89 (m, 1H), 7.1 (m, 1H), 7.28 (m, 1H), 7.75 (m, 2H), 8.00 (m, 1H), 8.71 (d, 1H).

### Step Three:

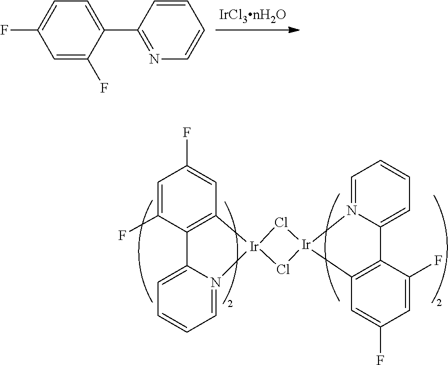

Added 700 ml of Ethylene Glycol ether to 2 L of four-neck flask, then added 36 g of the second-step products, stirred, solution turned yellow and clear. Then heated and refluxed. Dissolved 18 g of Iridous chloride in 200 ml of DI water, and then dripped the mixture in by using constant pressure drop funnel. After refluxed for 3 hours, then stop. Filtered the whole reaction solutions, and then cleaned the filter cake, in turn, with 80 ml of Acetone, 100 ml×2 of DI water, and 80 ml×2 of Acetone. Followed with vacuum drying process, 26.28G of earth yellow solid reached with 85% of yield rate.

### Step Four:

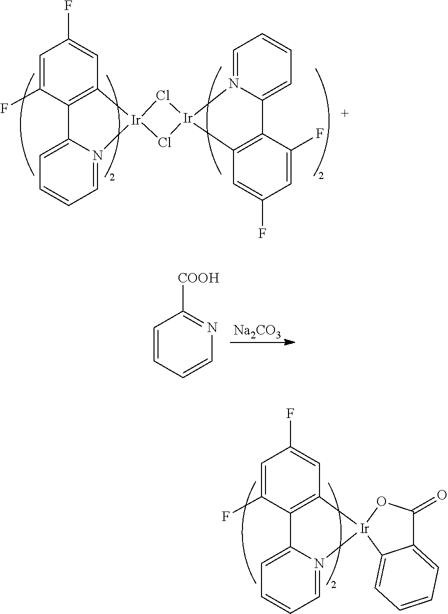

Added 1200 ml of Ethylene Glycol ether to 3 L of four-neck flask, followed with 20.2 g of Chlorendic compounds, stirred, Nitrogen gas filled in, then heated and refluxed. When the reflux occurred in the flask, added 12 g of solid sodium carbonate all at once. Dissolved pyridine Carboxylic acid in 300 ml of Ethylene Glycol ether, and then dripped the mixture in forty minutes by using constant pressure drop funnel.

Refluxed with stirring between 130° C. and 135° C., with sampling interval 1 hour, and 2-3 hours later terminated the reaction. (HPLC: products 95%-97%)

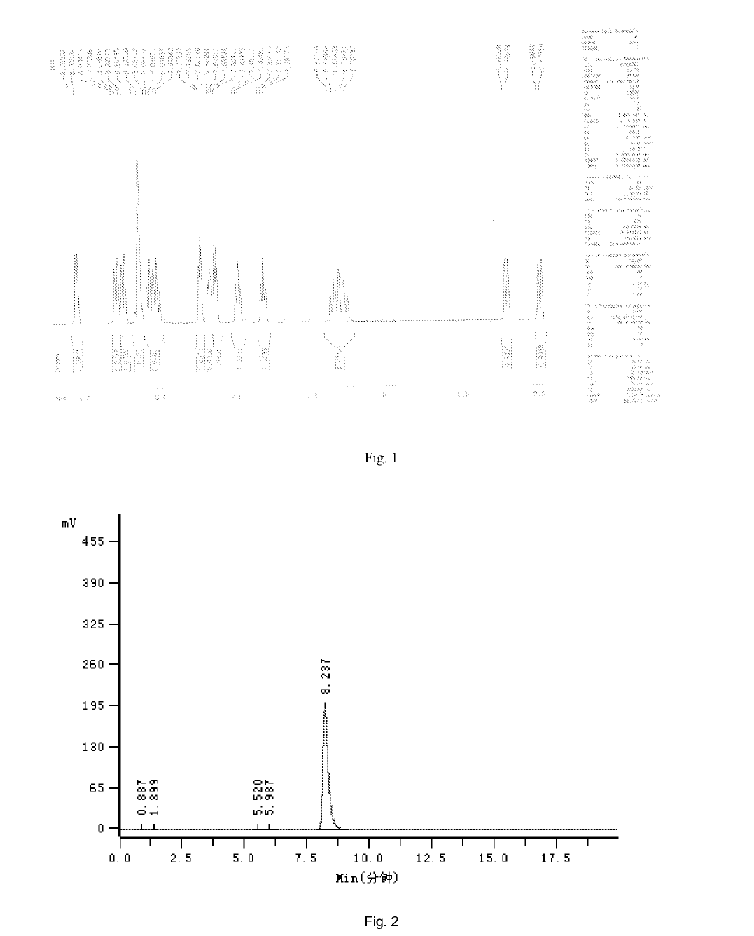

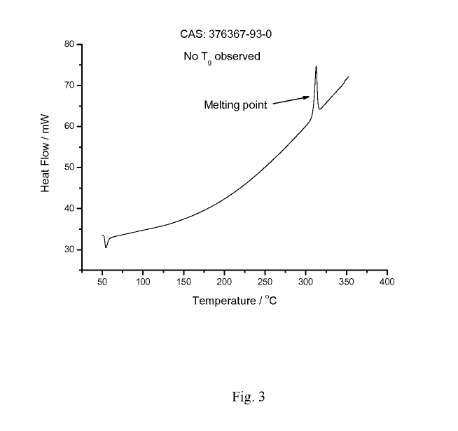

Cooled the reaction system, added 5.5 L of ethyl acetate, and then rinsed with 4 L×3 DI water. Dried the organic phase and concentrated solvent with 200 g of Magnesium Sulfate, and deep yellow solid substances reached. By using Methylene Chloride and Petroleum Ether, the deep yellow solid substances were recrystallized and 16 g of luminous yellow solid substances with 75% of yield rate reached. (HPLC:99.1%) See FIG. 1 and FIG. 2.

¹H—NMR (CDCl₃, 400Hz): 8.52 (1H, d), 8.21-8.27 (2H, m), 8.11-8.12 (2H, m), 8.00 (2H, m), 7.4-7.7 (2H, m), 7.3 (1H, m), 6.8 (1H, m), 6.7 (2H, m), 5.6-5.7 (1H, d), 5.4 (1H, d).

The results of analysis of liquid chromatogram FIG. 2 shown in the table below.

### The Analytical Results

| | Chromato- | | | | | | Resolution | Theoretical |
|---|---|---|---|---|---|---|---|---|
| | graphic | | | | Area/ | Peak | Tailing | plate |
| Peak | component | RT | Area | Height | Height | area ratio | factor | number |
| 1 | 0.887 | 2709.7 | 99.0 | 27.367 | 0.0470 | 1.296 | 2.310 | 59.0 |
| 2 | 1.399 | 1594.5 | 80.2 | 19.885 | 0.0277 | 1.296 | 2.318 | 285.2 |
| 3 | 5.520 | 24034.8 | 1099.9 | 21.851 | 0.4172 | 13.476 | 1.684 | 6138.2 |
| 4 | 5.987 | 22220.9 | 907.4 | 24.490 | 0.3857 | 1.548 | 1.621 | 5500.1 |
| 5 | 8.237 | 5710667.1 | 192154.2 | 29.719 | 99.1224 | 6.556 | 1.614 | 8130.8 |
| Total: | | 5761226.9 | 194340.7 | | 100.0000 | | | |

### Embodiment 2: Tris (2-Phenylpyridine) Iridium/Ir (ppy)₃

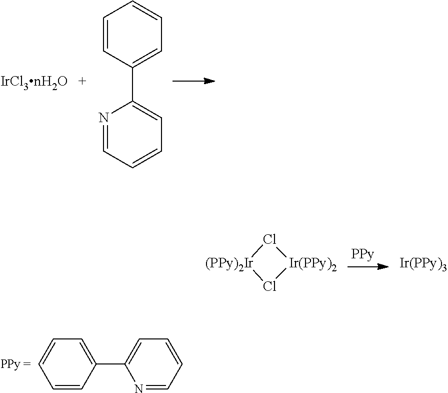

### Step One:

Added 700 ml of Ethylene Glycol ether to 2 L of four-neck flask, followed with 30 g of 2-Phenylpyridine, stirred, solution turned light yellow and clear, then heated and refluxed. Dissolved 20 g of Iridous chloride in 250 ml of DI water, and then dripped the mixture in by using constant pressure drop funnel. After refluxed for 3 hours, then stop. Filtered the whole reaction solutions, and then cleaned the filter cake, in turn, with 80 ml of Acetone, 100 ml×2 of DI water, and 80 ml×2 of Acetone. Followed with vacuum drying process, 28 g of earth yellow solid reached with 80% of yield rate.

### Step Two:

Added 1200 ml of Ethylene Glycol ether to 3 L of four-neck flask, followed with 18 g of Chlorendic compounds, stirred, Nitrogen gas filled in, then heated and refluxed. When the reflux occurred in the flask, added 12 g of solid sodium carbonate all at once. Dissolved 2-Phenyl Pyridine in 100 ml of Glycerol, and then dripped the mixture in forty minutes by using constant pressure drop funnel. Refluxed with stirring, with sampling interval 1 hour, and 2-3 hours later terminated the reaction. (HPLC: products 95%-97%)

Cooled the reaction system, added 5.5 L of ethyl acetate, and then rinsed with 4 L×3 DI water. Dried the organic phase and concentrated solvent with 200 g of Magnesium Sulfate, and deep yellow solid substances reached. By using Methyl Cyanide, the deep yellow solid substances were recrystallized and 15 g of luminous yellow solid substances with 78% of yield rate reached.

¹H—NMR (CDCl₃, 400Hz): 7.84 (m, 3H), 7.58 (m, 6H), 7.48 (m, 3H), 6.83 (m, 6H), 6.69 (m, 6H).

### Embodiment 3: Acetyl Pyruvate bis (2-Phenyl Pyridine) Iridium/Ir(ppy)₂(acac)

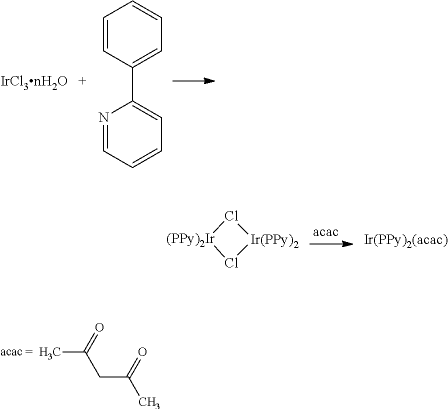

If 2-Phenyl Pyridine in step two of the embodiment 2 above was replaced with Acetylacetone, high purity Acetyl Pyruvate bis (2-Phenyl Pyridine) Iridium can be produced.

¹HNMR (360 MHz, acetone-d⁶), ppm: 8.55 (d, 2H), 8.07 (d, 2H), 7.91 (t, 2H), 7.63 (d, 2H), 7.32 (t, 2H), 6.74 (t, 2H), 6.59 (t, 2H), 6.21 (d, 2H), 5.26 (s, 1H), 1.69 (s, 6H).

### Embodiment 4: Bis (2-(2,4-Difluorophenyl) Pyridine) ((1-Pyrazolyl) Boron) Iridium/FIr6

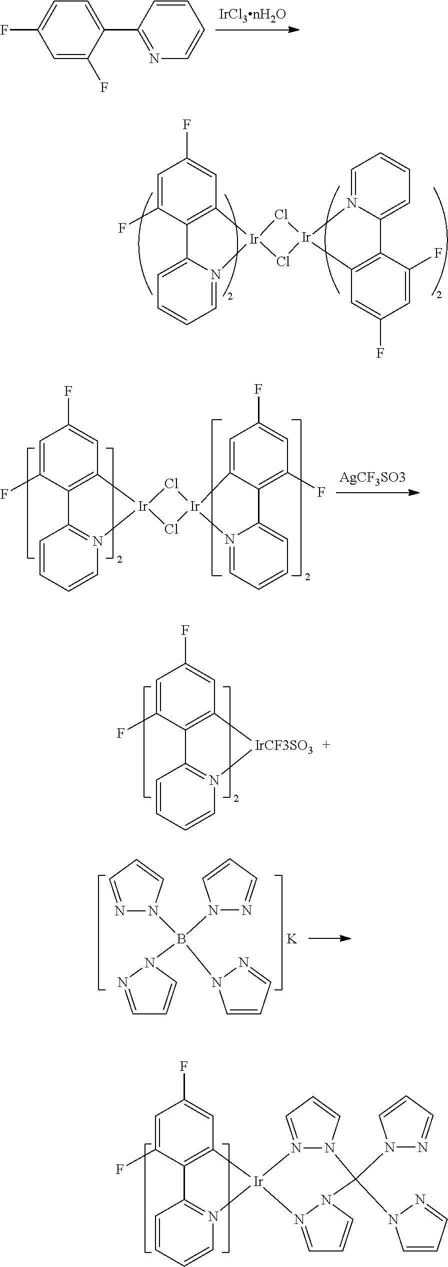

Added 17 of Chlorendic compounds used in embodiment 1 to 1 L of single-neck flask, followed with Silver trifluoromethanesulfonate and 800 ml of Dichloromethane, stirred, a lot of muddy in the solution appeared. Then after stirred for two hours, filtered and concentrated solution, and white solid substances reached. Added the concentrates followed with 300 ml of Acetonitrile to four-neck flask, and insoluble after stirred. Then filled with Nitrogen and warmed the solution, and dripped in the mixture of 17.5 g of Potassium Tetrapyrazolyl Borate and Acetonitrile. As refluxed, large quantities of solid substances continuously appeared. This step reaction lasted 2 hours, then stop. Then filtered reacting liquid, reached yellow solid substances, and recrystallized by using Dichloromethane and Methanol to 18 g products with 80% of yield rate.

¹HNMR (360 MHz, CDCl3), ppm: 8.15 (d, 2H), 7.72 (s, 2H), 7.60 (vt, 2H), 7.28 (s, 2H), 7.13 (d, 2H), 6.92 (d, 2H), 6.74 (d, 2H), 6.44 (m, 2H), 6.23 (vt, 2H), 6.18 (s, 2H), 6.03 (s, 2H), 5.55 (dd, 2H).

1. Two sole reactions are needed for the synthesis of organometallic iridium compounds just as follows: (1) Iridium tri-halides hydrates react with Neutral ligands, the reaction gives di-iridium compounds bridging with halogenated branch: L₂Ir(μ−X)₂IrL₂, L: Bi-coordinated circular metal ligand formed from Neutral ligands, (μ−X): Halogenated bridge. (2) Di-iridium compounds branched with halogenated bridge react with a slightly excessive dose of ligand B, then the reaction gives [Ĉ]N]₂IR (LX), LX: Ligand III formed from ligand B. The distinguishing features of the method are as described below. Proceed of the first as follows: Iridium tri-halides hydrates are dissolved in water, and then dropped in the reflux of Neutral ligands and soluble organic solvent A. After 2-6 hours refluxed, the output would be filtered and then recrystallized, finally gives the di-iridium compounds branched with halogenated bridge: L₂Ir(μ−X)₂IrL₂, L.

2. According to the method introduced from Clause 1 in the claim, the soluble organic solvent A is as follows: 2-ethoxyethanol, 2-methoxyethanol, 1,3-propandiol, 1,2-propanediol, glycol, or glycerol, and 3:1-0:1 volume ratio between the above-mentioned soluble organic solvents and water is recommended.

3. According to the method Clause 1, the minimum volume of either the above-mentioned soluble organic solvent A or the water must be enough dissolving step.

4. According to the method Clause 1, the above-mentioned Iridium tri-halides hydrates are Iridium tri-chloride hydrates.

5. According to the method Clause 1, the second step reaction proceeded as follows: Dissolved ligand B in solvent B, then dropped in the reflux of which dissolving di-iridium compounds branched with halogenated bridge, solvent B and carbonate solution. Then after 1-6 hours refluxed, separation, gives the end products by final recrystallized step.

6. According to the method introduced from Clause 5 in the claim, the above-mentioned solvent B: 2-ethoxyethanol, 2-methoxyethanol, 1,3-Propandiol, 1,2-propanediol, glycol, glycerol, 1,2-dichloroethane, acetonitrile, 1,2-diethoxyethanol, or 1,2-dimethoxyethanol.

7. According to the method Clause 5, the preparation of mixed solution: Dissolved di-iridium compounds branched with halogenated bridge in solvent B, refluxed and then added in with carbonate solution.

8. According to the method Clause 5, the minimum volume of solvent B must be enough dissolving step.

9. According to the method Clause 5, the reflux step last 2-4 hours.

10. According to the method introduced from Clause 1 in the claim, the above-mentioned ligand B means Neutral ligand.
